(19) United States
(12) Patent Application Publication
(10) Pub. No.: US 2012/0237672 A1
(43) Pub. Date: Sep. 20, 2012

(54) Method for Tuning Photonic Crystal

(75) Inventors: Jer-Liang Yeh, Hsinchu City (TW); Chia-Tsung Chan, Hsinchu City (TW)

(73) Assignee: Jer-Liang Yeh, Hsinchu City (TW)

(21) Appl. No.: 13/234,384

(22) Filed: Sep. 16, 2011

(30) Foreign Application Priority Data
Mar. 17, 2011 (TW) 100109062

(51) Int. Cl. B05D 5/06

(52) U.S. Cl. 427/162

(57) ABSTRACT

The present invention is to provide a method for tuning photonic crystal. The photonic crystal has a plurality of voids and is immersed in a predetermined liquid. The predetermined liquid has a refractive index. The method for tuning photonic crystal is used to control the liquid-solid affinity for adjusting the volume of the voids occupied by the predetermined liquid. An equivalent refractive index of the voids can be changed to adjust the reflection spectrum of the photonic crystal. The reflective color of the photonic crystal can be dynamically tuned.

### BACKGROUND OF THE INVENTION

1. Field of the invention

The present invention relates to a method for tuning a photonic crystal. More particularly, the present invention relates to a method for tuning a photonic crystal by replacing different liquids with different capillary actions. Accordingly, the color of the photonic crystal will be changed dynamically.

2. Description of the prior art

A photonic crystal comprises a nano structure with periodic refractive indexes which can change the transmission of a light. In the field, the photonic crystal is expected to be used for optical communications, display devices or optical computers. At present, the main technologies of the photonic crystal are to manufacture and drive the ways of modulation. In prior art, the discoloration technology of the photonic crystal is to change colors by electro chemistry. More particularly, the refractive indexes of materials are changed by the expansion of a chemical solvent, and then the colors of the photonic crystal will be changed. However, because of the material and the diffusion velocity of liquid (˜10-3 m/s), the method for tuning the photonic crystal is limited in the prior art. The colors of the photonic crystal cannot be changed dynamically with a fast response time, so that the development and the application of the photonic crystal will be limited.

To sum up, it is an important issue about how to develop a method for tuning a photonic crystal with features of fast response time and dynamical discoloration at the same time.

### SUMMARY OF THE INVENTION

Accordingly, a scope of the invention is to provide a method for tuning a photonic crystal. The photonic crystal has a plurality of voids and is immersed in a predetermined liquid. The predetermined liquid has a refractive index. The method for tuning the photonic crystal is used to control a liquid-solid affinity for adjusting a volume of the voids occupied by the predetermined liquid. An equivalent refractive index of the voids can be changed to adjust a reflection spectrum and a transmission spectrum of the photonic crystal accordingly. Thus, the color of the photonic crystal can be dynamically tuned.

According to an embodiment, the predetermined liquid can be a first liquid or a second liquid. The method for tuning a photonic crystal further comprises the following steps of: (S1) forming a plurality of flow channels from the plurality of voids of the photonic crystal and forming a hydrophobic layer or a hydrophilic layer from each surface of each void; (S2) immersing the photonic crystal in the first liquid; and (S3) replacing the first liquid by the second liquid and letting the photonic crystal be immersed in the second liquid. Each void can be a nanoscale void and each flow channel can be a nanoscale flow channel. In the step (S1), a heptadecafluoro-1,1,2,2-tetrahydrodecyltrichlorosilane self-assembled monolayer is formed on the surface of each void by a molecular vapor deposition process.

In practice, the first liquid can be an ethanol-water mixture with 30% mass concentration, the second liquid can be an ethanol-water mixture with 95% mass concentration. The first liquid can be replaced by waters. In the step (S2), if the photonic crystal is immersed in the ethanol-water mixture with 30% mass concentration, the said ethanol-water mixture cannot penetrate into the plurality of voids because of the hydrophobicity of the surface of each voids. Accordingly, most volume of each void is occupied by gas. In the step (S3), if the photonic crystal is immersed in the ethanol-water mixture with 95% mass concentration, the said ethanol-water mixture will penetrate into the plurality of voids by the capillary attraction produced because of the low surface tension of the ethanol. Accordingly, most volume of each void is occupied by liquid

To sum up, the invention is based on the capillary action of liquid. The volume of each void occupied by liquid can be changed by delivering the liquid in and out to adjust the equivalent refractive index of the plurality of voids. Accordingly, the reflection spectrum and the transmission spectrum of the photonic crystal can be changed, so that the colors of the photonic crystal will be dynamically tuned.

### BRIEF DESCRIPTION OF THE APPENDED DRAWINGS

FIG. 1 illustrates a flow chart of a method for tuning a photonic crystal according to the invention.

FIG. 2 illustrates a schematic diagram of a photonic crystal immersed in a first fluid according to the invention.

FIG. 3 illustrates a schematic diagram of a photonic crystal immersed in a second fluid according to the invention.

FIG. 4 illustrates a cross sectional view of a photonic crystal applied to a scanning electron microscope according to the invention.

FIG. 5 illustrates a comparison table of a color-changing technology of a photonic crystal.

### DETAILED DESCRIPTION OF THE INVENTION

The invention is to provide a method for tuning a photonic crystal. The photonic crystal has a plurality of voids and is immersed in a predetermined liquid. The predetermined liquid has a refractive index. The method for tuning the photonic crystal is used to control a liquid-solid affinity for adjusting a volume of the voids occupied by the predetermined liquid. An equivalent refractive index of the voids can be changed to adjust a reflection spectrum and a transmission spectrum of the photonic crystal accordingly. Thus, the color of the photonic crystal can be dynamically tuned.

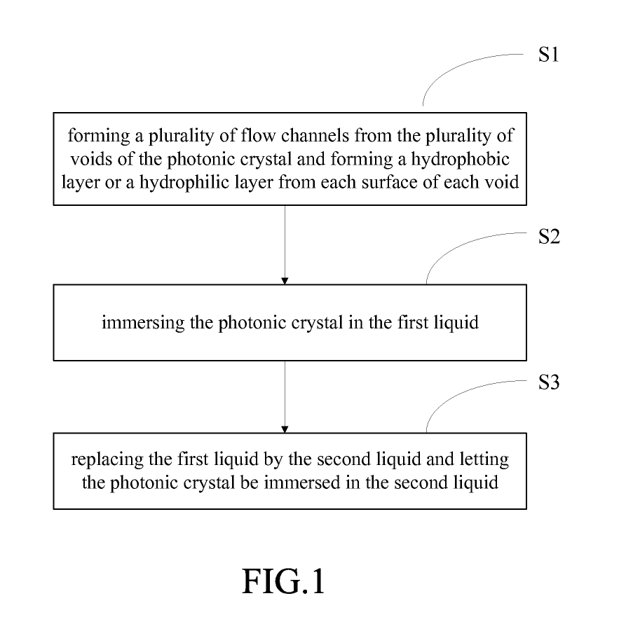

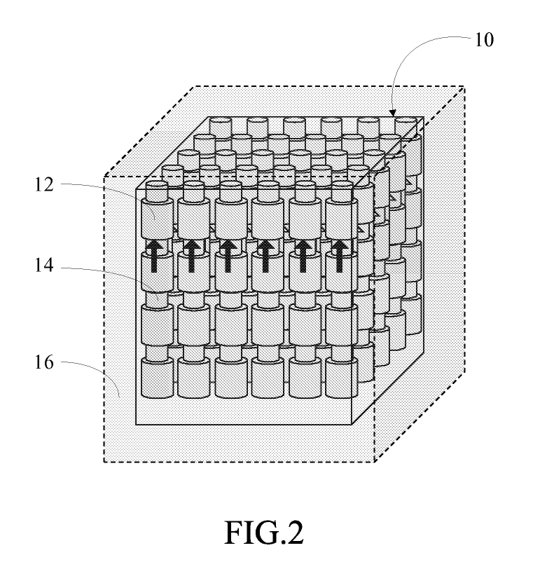

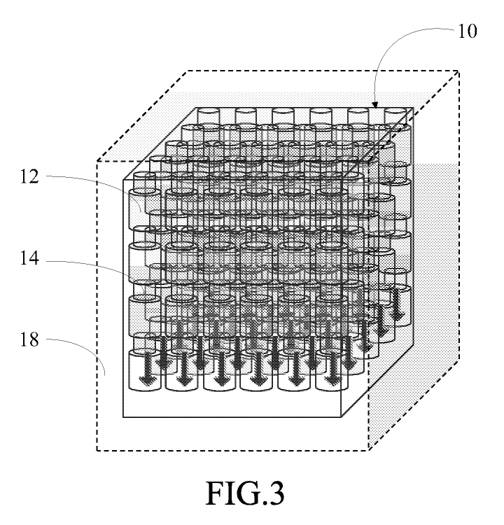

Please refer to FIG. 1 to FIG. 3. FIG. 1 illustrates a flow chart of a method for tuning a photonic crystal according to the invention. FIG. 2 illustrates a schematic diagram of a photonic crystal immersed in a first fluid according to the invention. FIG. 3 illustrates a schematic diagram of a photonic crystal immersed in a second fluid according to the invention. According to an embodiment of the invention, the predetermined liquid can be a first liquid 16 or a second liquid 18. The predetermined liquid also can be a polar liquid or a nonpolar liquid. For example, the predetermined liquid can be waters, alcohols, colloids, surfactants or ionic liquids. Additionally, the predetermined liquid can be a single liquid or a liquid mixture. The method for tuning a photonic crystal 10 further comprises the following steps of: (S1) forming a plurality of flow channels 14 from the plurality of voids 12 of the photonic crystal 10 and forming a hydrophobic layer or a hydrophilic layer from each surface of each void 12; (S2) immersing the photonic crystal 10 in the first liquid 16; and (S3) replacing the first liquid 16 by the second liquid 18 and letting the photonic crystal 10 be immersed in the second liquid 18.

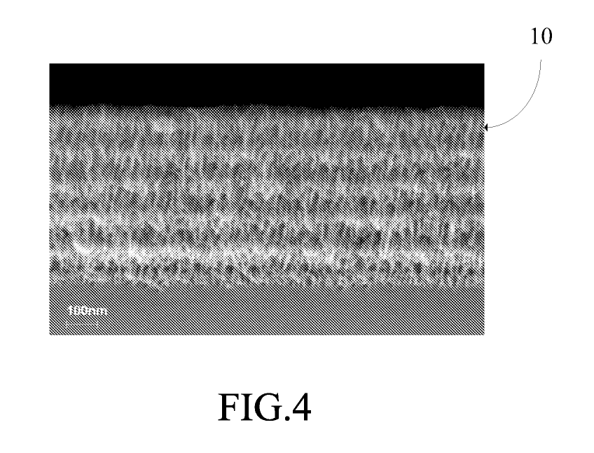

Please refer to FIG. 4. FIG. 4 illustrates a cross sectional view of a photonic crystal applied to a scanning electron microscope according to the invention. In practice, the photonic crystal 10 can be, but not limited to a porous silicon-based photonic crystal. The photonic crystal 10 can be manufactured by a silicon material, a polymer material or a semiconductor material such as silicon, silicon dioxide, silicon nitride, titanium oxide, photoresist, polystyrene (PS) or polymethylmethacrylate (PMMA, acrylic). Additionally, the porous silicon-based photonic crystal has the plurality of voids 12. Each void 12 can be a nanoscale void, such as ten nanometers. Each flow channel is a nanoscale flow channel. Furthermore, the photonic crystal 10 can be a porous silicon-based photonic crystal which comprises layers with different void densities. In practice, the photonic crystal 10 can be a porous silicon-based photonic crystal which comprises 5½ layers with different void densities (as shown in FIG. 4). The photonic crystal immersed in different liquids or in different liquid mixtures can be tuned in the range of a visible spectrum. The liquid can be an ethanol-water mixture with mass percentage concentration ranges from 0% to 90% and variation range of spectrum ranges from 400 nm to 700 nm.

In practice, in the step (S1) a heptadecafluoro-1,1,2,2-tetrahydrodecyltrichlorosilane self-assembled monolayer is formed on the surface of each void 12 by a molecular vapor deposition process. Thus, a plurality of flow channels 14 will be formed from the plurality of voids 12 of the photonic crystal 10. Each flow channel 14 is a nanoscale flow channel.

Additionally, a surface tension of the first liquid 16 is different from a surface tension of the second liquid 18. The first liquid 16 and the second liquid 18 can be a binary liquid mixture with different mass percentage concentrations individually. The binary liquid mixture can be an alcoholic aqueous solution.

In the embodiment, the first liquid 16 can be an ethanol-water mixture with 30% mass concentration, the second liquid 18 can be an ethanol-water mixture with 95% mass concentration. The first liquid 16 can be replaced by waters. Wherein, in the step (S2), if the photonic crystal 10 is immersed in the ethanol-water mixture with 30% mass concentration, the said ethanol-water mixture cannot penetrate into the plurality of voids 12 because of the hydrophobicity of the surface of each voids 12. Accordingly, most volume of each void 12 is occupied by gas (as shown in FIG. 2).

In the step (S3), if the photonic crystal 10 is immersed in the ethanol-water mixture with 95% mass concentration, the said ethanol-water mixture will penetrate into the plurality of voids 12 by the capillary attraction produced because of the low surface tension of the ethanol. Accordingly, most volume of each void 12 is occupied by liquid (as shown in FIG. 3). Because of the volume ratio occupied by liquid can be changed, the refractive index of the plurality of voids 12 will be changed. Furthermore, the colors of the photonic crystal 10 will also be changed.

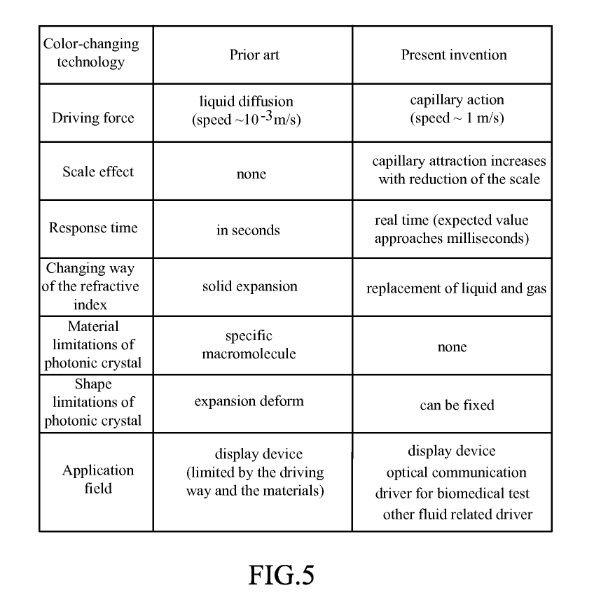

Please refer to FIG. 5. FIG. 5 illustrates a comparison table of a color-changing technology of a photonic crystal. Compared to the color-changing technology in the prior art, the driving force, scale effect, response time, color-changing way of the refractive index, material limitations of the photonic crystal, shape limitations of the photonic crystal and application field of the invention are all better than the prior art.

Compared to the prior art, the invention is based on the capillary action of liquid.

The volume of each void occupied by liquid can be changed by delivering the liquid in and out to adjust the equivalent refractive index of the plurality of voids. Accordingly, the reflection spectrum and the transmission spectrum of the photonic crystal can be changed, so that the colors of the photonic crystal will be dynamically tuned. Additionally, the invention tunes the refractive index by replacing liquid and gas and is different from the prior art by replacing liquid and solid. Furthermore, the invention uses the capillary action as a driving force in a nanoscale, the effect of the invention is hundredfold better than the prior art which uses the atmospheric pressure. Finally, in the invention, a single-molecule hydrophobic layer can be coated on the internal surface of the plurality of voids. The liquid can be delivered in and out within the plurality of voids which have a diameter of 10 nm and a depth of 500 nm.

To sun up, the invention is the only method for tuning the photonic crystal with features of fast response time and dynamical discoloration at the same time.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for tuning a photonic crystal, wherein the photonic crystal has a plurality of voids and is immersed in a predetermined liquid, the predetermined liquid has a refractive index, the method for tuning the photonic crystal is used to control a liquid-solid affinity for adjusting a volume of the voids occupied by the predetermined liquid, an equivalent refractive index of the voids can be changed to adjust a reflection spectrum and a transmission spectrum of the photonic crystal accordingly.

2. The method for tuning the photonic crystal of claim 1, wherein the predetermined liquid can be a first liquid or a second liquid, the method for tuning the photonic crystal comprises the following steps of:
(S1) forming a plurality of flow channels from the plurality of voids of the photonic crystal and forming a hydrophobic layer or a hydrophilic layer from each surface of each void;
(S2) immersing the photonic crystal in the first liquid; and
(S3) replacing the first liquid by the second liquid and letting the photonic crystal be immersed in the second liquid.

3. The method for tuning the photonic crystal of claim 2, wherein a surface tension of the first liquid is different from a surface tension of the second liquid.

4. The method for tuning the photonic crystal of claim 3, wherein the first liquid and the second liquid can be a binary liquid mixture with different mass percentage concentrations individually.

5. The method for tuning the photonic crystal of claim 4, wherein the first liquid and the second liquid can be an alcoholic aqueous solution with different mass percentage concentrations individually.

6. The method for tuning the photonic crystal of claim 5, wherein the first liquid can be an ethanol-water mixture with 30% mass concentration, the second liquid can be an ethanol-water mixture with 95% mass concentration.

7. The method for tuning the photonic crystal of claim 6, wherein in the step (S2), if the photonic crystal is immersed in the ethanol-water mixture with 30% mass concentration, the ethanol-water mixture cannot penetrate into the plurality of voids, in the step (S3), if the photonic crystal is immersed in the ethanol-water mixture with 95% mass concentration, the ethanol-water mixture can penetrate into the plurality of voids.

8. The method for tuning the photonic crystal of claim 2, wherein each void is a nanoscale void, each flow channel is a nanoscale flow channel.

9. The method for tuning the photonic crystal of claim 2, wherein the hydrophobic layer is a heptadecafluoro-1,1,2,2-tetrahydrodecyltrichlorosilane self-assembled monolayer.

10. The method for tuning the photonic crystal of claim 9, wherein the heptadecafluoro-1,1,2,2-tetrahydrodecyltrichlorosilane self-assembled monolayer is formed on the surface of each void by a molecular vapor deposition process.

11. The method for tuning the photonic crystal of claim 1, wherein the photonic crystal is a porous silicon-based photonic crystal.

12. The method for tuning the photonic crystal of claim 1, wherein the predetermined liquid can be a polar liquid or a nonpolar liquid.

13. The method for tuning the photonic crystal of claim 12, wherein the predetermined liquid can be waters, alcohols, colloids, surfactants or ionic liquids.

14. The method for tuning the photonic crystal of claim 1, wherein the photonic crystal is manufactured by a silicon material, a polymer material or a semiconductor material.

15. The method for tuning the photonic crystal of claim 14, wherein the photonic crystal is manufactured by silicon, silicon dioxide, silicon nitride, titanium oxide, photoresist, polystyrene (PS) or polymethylmethacrylate (PMMA, acrylic).
